(19) United States
(12) Patent Application Publication
(10) Pub. No.: US 2016/0028718 A1
(43) Pub. Date: Jan. 28, 2016

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Ryotaro HAYASHI, Kanagawa (JP)

(73) Assignee: FUJI XEROX CO., LTD., Tokyo (JP)

(21) Appl. No.: 14/678,407

(22) Filed: Apr. 3, 2015

(30) Foreign Application Priority Data
Jul. 23, 2014 (JP) 2014-149791

(51) Int. Cl. H04L 29/06

(52) U.S. Cl. CPC H04L 63/0807; H04L 63/10

(57) ABSTRACT

An information processing apparatus includes a reception unit, an operation control unit, and an invalidation unit. The reception unit receives an operation on data. The operation control unit performs control of permitting, from among received operations, a first operation which is associated with authorization information for a case where authorization information indicating authorization for an operation is valid, and rejecting the first operation for a case where the authorization information is invalid and a second operation which is different from the first operation. The invalidation unit invalidates the authorization information when the second operation is rejected.

### CROSS-REFERENCE TO RELATED APPLICATIONS

This application is based on and claims priority under 35 USC 119 from Japanese Patent Application No. 2014-149791 filed Jul. 23, 2014.

### BACKGROUND

(i) Technical Field

The present invention relates to an information processing apparatus, an information processing method, and a non-transitory computer readable medium.

(ii) Related Art

In systems that manage services provided through a network, the propriety of the use of a service may be controlled by using an access ticket issued by a client.

In the case where authorization information indicating the authorization for an operation on data is acquired improperly by a third party and the operation on the data is requested improperly by using the authorization information, it is not possible to distinguish whether or not the request is made by a duly authorized person.

### SUMMARY

According to an aspect of the invention, there is provided an information processing apparatus including a reception unit, an operation control unit, and an invalidation unit. The reception unit receives an operation on data. The operation control unit performs control of permitting, from among received operations, a first operation which is associated with authorization information for a case where authorization information indicating authorization for an operation is valid, and rejecting the first operation for a case where the authorization information is invalid and a second operation which is different from the first operation. The invalidation unit invalidates the authorization information when the second operation is rejected.

### BRIEF DESCRIPTION OF THE DRAWINGS

Exemplary embodiments of the present invention will be described in detail based on the following figures, wherein:

FIG. 1 is a diagram illustrating an overall configuration of an access management system according to a first exemplary embodiment;

FIG. 2 is a block diagram illustrating a hardware configuration of a first service server according to the first exemplary embodiment;

FIGS. 3A, 3B, and 3C are explanatory diagrams illustrating data stored in the first service server according to the first exemplary embodiment;

FIG. 4 is a block diagram illustrating a hardware configuration of a second service server according to the first exemplary embodiment;

FIG. 5 is a block diagram illustrating a hardware configuration of a client apparatus according to the first exemplary embodiment;

FIG. 6 is a block diagram illustrating a functional configuration of the access management system according to the first exemplary embodiment;

FIG. 7 is a sequence diagram illustrating operation of the access management system at the time of issuing an access ticket;

FIG. 8 is a sequence diagram illustrating operation of the access management system at the time of an operation;

FIGS. 9A and 9B are explanatory diagrams illustrating data stored in the first service server according to the first exemplary embodiment;

FIGS. 10A and 10B are block diagrams illustrating a functional configuration of an access management system according to a second exemplary embodiment;

FIG. 11 is an explanatory diagram illustrating data stored in a first service server according to the second exemplary embodiment;

FIG. 12 is a sequence diagram illustrating operation of the access management system at the time of issuing an access ticket;

FIG. 13 is a sequence diagram illustrating operation of the access management system at the time of an operation;

FIG. 14 is a sequence diagram illustrating operation of the access management system at the time of an operation;

FIGS. 15A and 15B are explanatory diagrams illustrating data stored in the first service server according to the second exemplary embodiment;

FIGS. 16A and 16B are explanatory diagrams illustrating data stored in the first service server;

FIG. 17 is an explanatory diagram illustrating data stored in the first service server;

FIG. 18 is an explanatory diagram illustrating data stored in the first service server;

FIG. 19 is an explanatory diagram illustrating data stored in the first service server;

FIG. 20 is an explanatory diagram illustrating data stored in the first service server; and

FIGS. 21A and 21B are explanatory diagrams illustrating data stored in a first service server according to a first variation.

### DETAILED DESCRIPTION

### First Exemplary Embodiment

A first exemplary embodiment of the present invention will be described below with reference to the accompanying drawings.

FIG. 1 is a diagram illustrating an overall configuration of an access management system 1 according to an exemplary embodiment of the present invention. The access management system 1 includes a first service server 10, a second service server 20, and plural client apparatuses 30 (30A and 30B). The first service server 10, the second service server 20, and the plural client apparatuses 30 are each connected to a communication line NW. The communication line NW is, for example, a public communication line which includes a mobile communication network, a gateway device, and the Internet. However, the communication line NW may be a different type of communication line (communication network), such as a local area network (LAN).

FIG. 1 illustrates the two client apparatuses 30, which are a client apparatus 30A and a client apparatus 30B. However, three or more client apparatuses 30 may be provided. The client apparatus 30A and the client apparatus 30B are used by different users.

The first service server 10 is an example of an information processing apparatus according to an aspect of the present invention, and is a server apparatus which provides a service in accordance with an object managed by the apparatus. An object represents data which is a target for an operation. Examples of an object include various files (electronic files) representing documents and the like and folders under which data is stored. The service used in the first exemplary embodiment is a service for achieving synchronization between an object managed by the first service server 10 and an object managed by the second service server 20, through access to the second service server 20 by the client apparatus 30. Information processing using an object includes various types of processing performed by using an object, such as addition (creation), display, and update (editing) of an object. The information processing according to the first exemplary embodiment is performed at regular intervals. For example, time intervals for the execution are regular (for example, intervals of one hour) or the order of execution of multiple types of information processing is regular (for example, display followed by update).

In order to provide services to the client apparatuses 30, the first service server 10 is linked with the second service server 20. Specifically, the first service server 10 issues an access ticket for a user of a client apparatus 30, and transmits the issued access ticket to the second service server 20. The access ticket is used for controlling the propriety of an operation on an object. The access ticket is an example of authorization information indicating the authorization for an operation on an object. When receiving a request for an operation on an object from the client apparatus 30, the second service server 20 accesses the first service server 10 by using the access ticket, and requests the first service server 10 for the operation on the object.

The client apparatuses 30 are terminal apparatuses, such as personal computers or tablet-type computers, which have an information processing function and a communication function to be used by users.

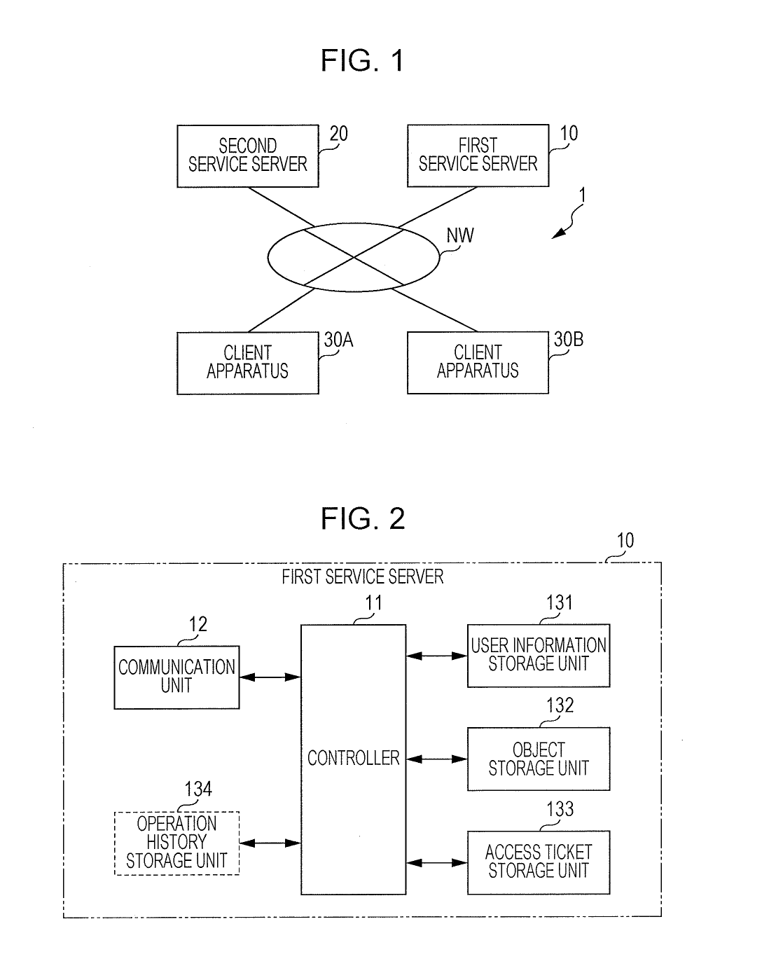

FIG. 2 is a block diagram illustrating a hardware configuration of the first service server 10. As illustrated in FIG. 2, the first service server 10 includes a controller 11, a communication unit 12, a user information storage unit 131, an object storage unit 132, and an access ticket storage unit 133. An operation history storage unit 134, which is expressed by a broken line in FIG. 2, is a component of a second exemplary embodiment, which will be described later, and is not relevant to the first exemplary embodiment.

The controller 11 is a microcomputer which includes a central processing unit (CPU) as an arithmetic processing unit, a read only memory (ROM), and a random access memory (RAM). The CPU controls the individual units of the first service server 10 by reading to the RAM a program which is stored in the ROM and executing the program. The communication unit 12 includes, for example, a modem and allows connection to and communication with the communication line NW. The user information storage unit 131, the object storage unit 132, and the access ticket storage unit 133 are implemented by a storage device, such as a hard disk device. The user information storage unit 131, the object storage unit 132, and the access ticket storage unit 133 may be implemented by a single storage device or two or more storage devices.

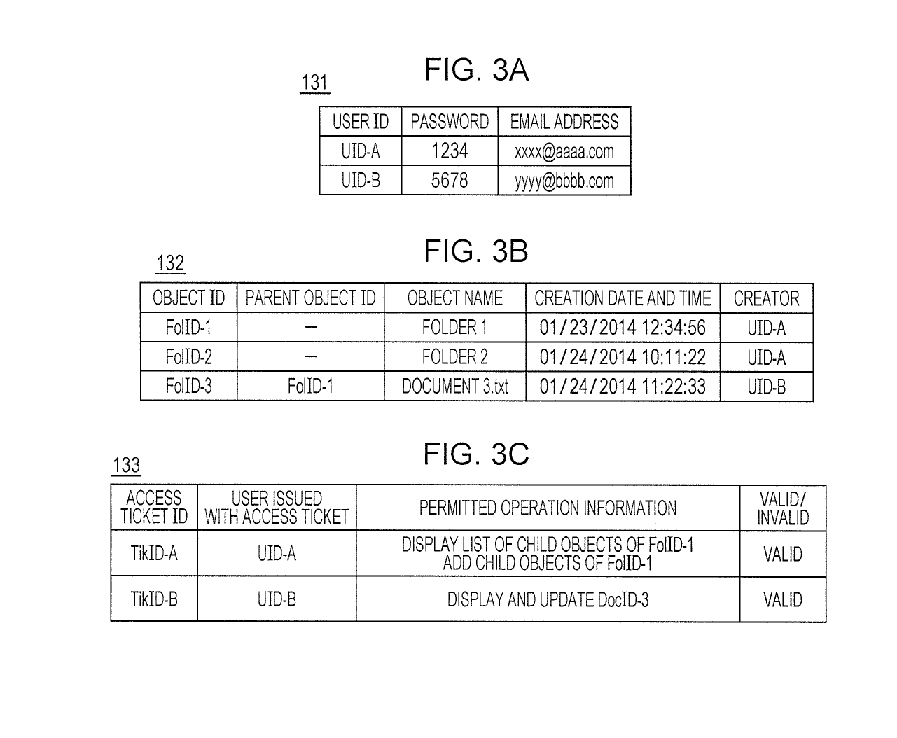

FIGS. 3A, 3B, and 3C are diagrams for explaining data stored in the first service server 10. FIG. 3A illustrates data stored in the user information storage unit 131. FIG. 3B illustrates data stored in the object storage unit 132. FIG. 3C illustrates data stored in the access ticket storage unit 133.

As illustrated in FIG. 3A, the user information storage unit 131 stores information of a user ID, a password, and an email address in association with each other for individual users of the client apparatuses 30. The user ID is an identifier for uniquely identifying a user. In this case, the user ID of the user of the client apparatus 30A is defined as “UID-A”, and the user ID of the user of the client apparatus 30B is defined as “UID-B”. The password is authentication information for authenticating a user of the client apparatus 30 who logs into the first service server 10. The email address is destination information for transmitting an email to the client apparatus 30.

The information in the user information storage unit 131 is, for example, stored when user registration is performed to the first service server 10.

As illustrated in FIG. 3B, the object storage unit 132 stores information of an object ID, a parent object ID, an object name, a creation date and time, and a creator in association with each other for each object to be stored.

The object ID is an identifier for uniquely identifying an object. The parent object ID is an object ID of an object associated with an upper level, which is, for example, an object ID of a folder in which a file is stored. The object name represents the name of an object (for example, a file name or folder name). The creation date and time represents the date and time when an object is created. The creator represents a user ID of a user of the client apparatus 30 who creates an object.

As illustrated in FIG. 3C, the access ticket storage unit 133 stores information of an access ticket ID, a user issued with access ticket, permitted operation information, and valid/invalid in association with each other for each issued access ticket.

The access ticket ID is an identifier for uniquely identifying an issued access ticket. The user issued with access ticket represents a user ID of a user of the client apparatus 30 to whom an access ticket has been issued. In the example of FIG. 3C, an access ticket with an access ticket ID “TikID-A” is issued to a user of the client apparatus 30A, and an access ticket with an access ticket ID “TikID-B” is issued to a user of the client apparatus 30B. The permitted operation information represents an operation permitted when an access ticket is valid. The permitted operation information is information which provides an access right to an object defined for an access ticket. Valid/invalid represents whether or not an access ticket is valid. When an access ticket is valid, an operation on data is permitted. In contrast, when an access ticket is invalid, an operation on data is not permitted (that is, rejected).

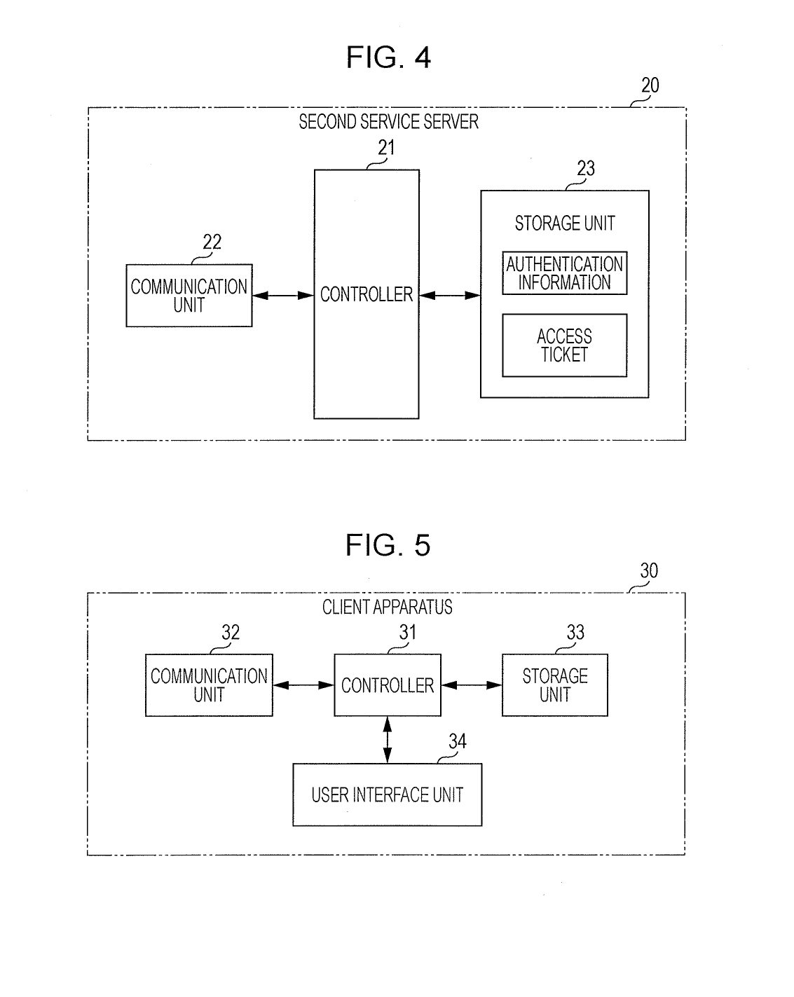

FIG. 4 is a block diagram illustrating a hardware configuration of the second service server 20. As illustrated in FIG. 4, the second service server 20 includes a controller 21, a communication unit 22, and a storage unit 23.

The controller 21 is a microcomputer which includes a CPU as an arithmetic processing unit, a ROM, and a RAM. The CPU controls the individual units of the second service server 20 by reading the RAM a program stored in the ROM and executing the program. The communication unit 22 includes, for example, a modem and allows connection to and communication with the communication line NW. The storage unit 23 includes a storage device, such as a hard disk device, and stores an object which is a target for synchronization, authentication information, and an access ticket. The authentication information stored in the storage unit 23 is information for authenticating a user of the client apparatus 30 who logs into the second service server 20. The access ticket stored in the storage unit 23 is an access ticket issued by the first service server 10.

FIG. 5 is a block diagram illustrating a hardware configuration of the client apparatuses 30. As illustrated in FIG. 5, the client apparatuses 30 each include a controller 31, a communication unit 32, a storage unit 33, and a user interface unit 34.

The controller 31 is a microcomputer which includes a CPU as an arithmetic processing unit, a ROM, and a RAM. The CPU controls the individual units of the client apparatus 30 by reading to the RAM a program stored in the ROM and executing the program. The communication unit 32 includes, for example, a modem and allows connection to and communication with the communication line NW. The storage unit 33 includes a storage device, such as a hard disk device, and stores a user ID, authentication information for the first service server 10, and authentication information for the second service server 20. The user interface unit 34 includes an operation part operated by a user (for example, a physical key or touch screen) and a display part for displaying an image (for example, a liquid crystal display).

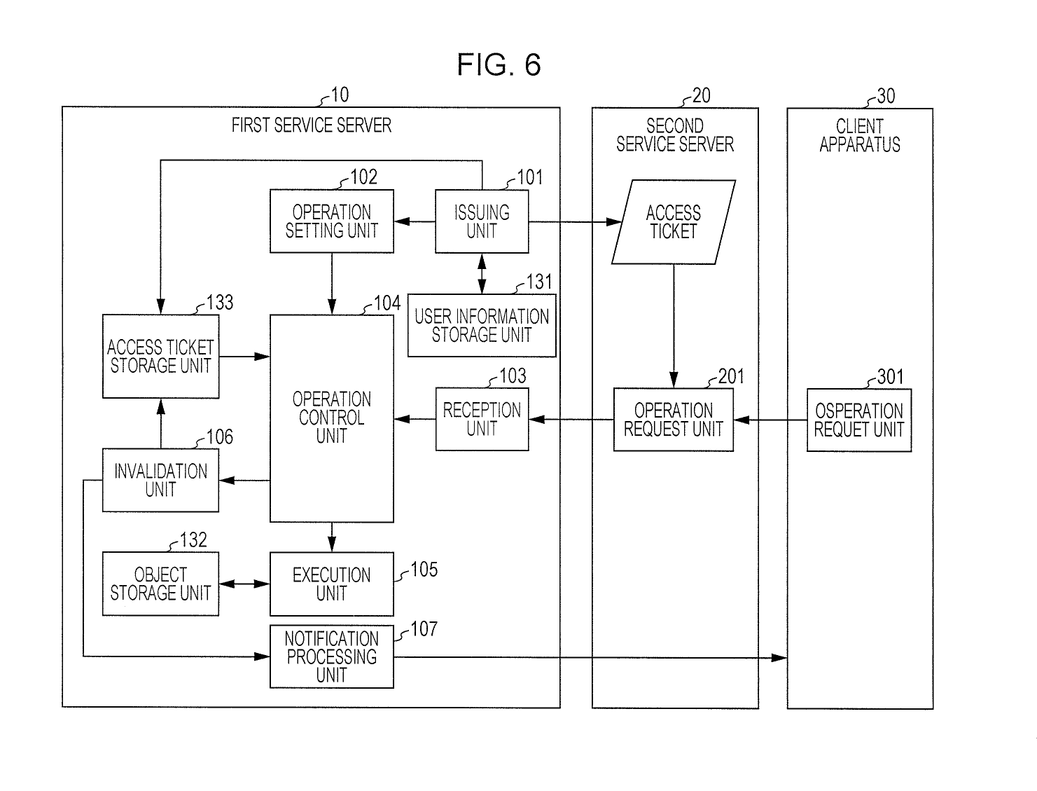

FIG. 6 is a block diagram illustrating a functional configuration of the access management system 1. FIG. 6 illustrates function blocks concerning an access ticket. As illustrated in FIG. 6, the controller 11 of the first service server 10 executes a program and thereby implements functions corresponding to an issuing unit 101, an operation setting unit 102, a reception unit 103, an operation control unit 104, an execution unit 105, an invalidation unit 106, and a notification processing unit 107.

The issuing unit 101 is an example of an issuing unit according to an aspect of the present invention, and issues an access ticket. The issuing unit 101 issues an access ticket for the user authenticated by the first service server 10 and the second service server 20. The access ticket issued by the issuing unit 101 is transmitted to the second service server 20. The issuing unit 101 causes the access ticket storage unit 133 to store (that is, register) information related to the issued access ticket.

The operation setting unit 102 is an example of a setting unit according to an aspect of the present invention, and sets an operation to be permitted in accordance with an access ticket when the access ticket is issued by the issuing unit 101. The operation setting unit 102 causes the access ticket storage unit 133 to store permitted operation information indicating the set operation.

The reception unit 103 is an example of a reception unit according to an aspect of the present invention, and receives an operation on an object in association with an access ticket. Specifically, an operation request unit 301 of the client apparatus 30 requests the second service server 20 for an operation on an object. In response to the request, an operation request unit 201 of the second service server 20 requests the first service server 10 for the operation by using the access ticket issued for the user of the client apparatus 30. The reception unit 103 receives the operation requested by the operation request unit 201.

The operation control unit 104 is an example of an operation control unit according to an aspect of the present invention, and controls the propriety of an operation received by the reception unit 103. The operation control unit 104 determines, based on the access ticket storage unit 133, whether the access ticket associated with the operation received by the reception unit 103 is valid or invalid, and determines whether or not the operation received by the reception unit 103 matches the operation indicated by the permitted operation information. The operation control unit 104 permits, when the access ticket is valid, the operation indicated by the permitted operation information (an example of a first operation according to an aspect of the present invention). The operation control unit 104 rejects an operation which is indicated by permitted operation information for the case where the access ticket is invalid, and an operation which is different from the operation indicated by the permitted operation information (an example of a second operation according to an aspect of the present invention).

The execution unit 105 is an example of an execution unit according to an aspect of the present invention. When an operation is permitted by the operation control unit 104, the execution unit 105 accesses the object storage unit 132 and performs information processing on an object in accordance with the operation. In contrast, when an operation is rejected by the operation control unit 104, the execution unit 105 does not perform information processing on an object.

The invalidation unit 106 is an example of an invalidation unit according to an aspect of the present invention, and invalidates an access ticket when an operation for the case where the access ticket is valid is rejected. When an operation indicated by the permitted operation information is rejected, based on the access ticket storage unit 133, the invalidation unit 106 invalidates an access ticket associated with the operation.

When the access ticket has already been invalidated, the invalidation unit 106 does not need to invalidate the access ticket.

The notification processing unit 107 is an example of a notification processing unit according to an aspect of the present invention. When an access ticket is invalidated, the notification processing unit 107 performs notification processing for a user who performs an operation associated with the access ticket. The notification processing unit 107 identifies, based on the user information storage unit 131, an email address of the client apparatus 30 of the user for which the access ticket has been invalidated, and transmits an email message indicating that the access ticket has been invalidated.

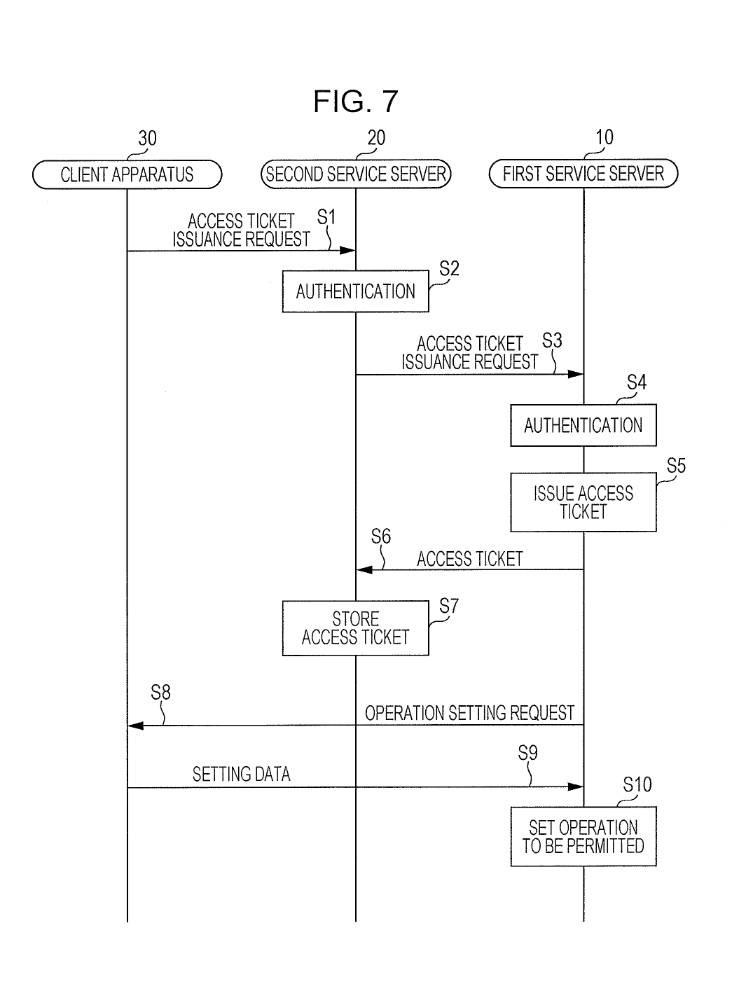

FIG. 7 is a sequence diagram illustrating operation of the access management system 1 at the time of issuing an access ticket.

First, the controller 31 of the client apparatus 30 transmits an access ticket issuance request to the second service server 20 through the communication unit 32 (step S1). The access ticket issuance request includes a user ID, authentication information for the first service server 10, and authentication information for the second service server 20.

Next, the controller 21 of the second service server 20 receives the access ticket issuance request through the communication unit 22, and performs processing for authenticating the user of the client apparatus 30 (step S2). Here, the controller 21 collates the authentication information for the second service server 20 included in the access ticket issuance request with authentication information stored in the storage unit 23. When authentication is successful, the controller 21 transmits the access ticket issuance request to the first service server 10 through the communication unit 22 (step S3). The access ticket issuance request includes the user ID and the authentication information for the first service server 10.

When authentication is unsuccessful, the controller 21 does not perform the processing of step S3.

Then, the controller 11 of the first service server 10 receives the access ticket issuance request through the communication unit 12, and performs processing for authenticating the user of the client apparatus 30 (step S4). Here, the controller 11 collates the authentication information for the first service server 10 included in the access ticket issuance request with a password stored for each user in the user information storage unit 131. When authentication is successful, the controller 11 issues an access ticket for the user for which authentication is successful (step S5). Upon issuing the access ticket, the controller 11 causes the access ticket storage unit 133 to store the access ticket ID of the issued access ticket and the user ID in association with each other. Furthermore, the controller 11 “validates” the access ticket.

When authentication is unsuccessful, the controller 11 does not perform the processing of step S5.

Then, the controller 11 transmits the issued access ticket to the second service server 20 through the communication unit 12 (step S6). The controller 21 of the second service server 20 causes the storage unit 23 to store the access ticket received through the communication unit 22, in a form in which the user issued with the access ticket (user ID) is able to be identified (step S7).

Next, the controller 11 of the first service server 10 transmits an operation setting request to the client apparatus 30 through the communication unit 12 (step S8). The operation setting request is a request for setting an operation to be permitted by the issued access ticket. The first service server 10 transmits the operation setting request to the client apparatus 30, for example, through the second service server 20. However, the operation setting request may be transmitted directly to the client apparatus 30.

The controller 11 of the first service server 10 receives a user operation for specifying an operation to be permitted by using the user interface unit 34. Then, the controller 11 transmits setting data indicating the specified operation to be permitted to the first service server 10 through the communication unit 32 (step S9). The controller 11 sets the operation to be permitted, in accordance with the operation indicated by the setting data which is received from the client apparatus 30 (step S10). Here, the controller 11 causes the access ticket storage unit 133 to store permitted operation information indicating an operation “display a list of child objects of FolID-1” and an operation “add child objects of FolID-1” (see FIG. 3C).

The setting data for setting an operation to be permitted may be included in an access ticket request. Timing of setting an operation to be permitted is not particularly specified.

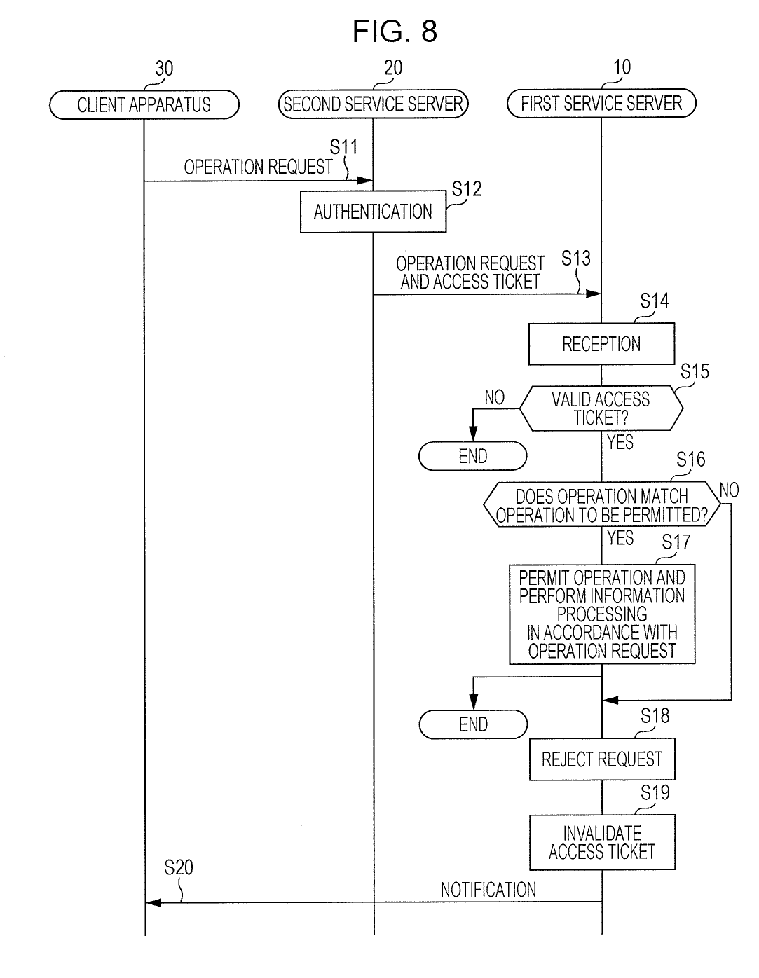

FIG. 8 is a sequence diagram illustrating operation of the access management system 1 at the time of an operation on an object.

First, the controller 31 of the client apparatus 30 transmits an operation request to the second service server 20 through the communication unit 32 (step S11). The operation request includes a user ID, authentication information for the second service server 20, and operation information indicating an operation to request.

The operation request transmitted from the client apparatus 30 is transmitted in accordance with a predetermined rule, without through a manual operation by the user of the client apparatus 30.

Then, the controller 21 of the second service server 20 receives the operation request through the communication unit 22, and performs processing for authenticating the user of the client apparatus 30 (step S12). The controller 21 collates the authentication information for the second service server 20 included in the operation request with authentication information stored in the storage unit 23. When authentication is successful, the controller 21 transmits the operation request received from the client apparatus 30 and the access ticket issued for the user of the user ID included in the operation request in association with each other to the first service server 10 through the communication unit 22 (step S13). Although not illustrated in FIG. 8, when an operation for object synchronization is requested, the controller 21 performs information processing on the object in accordance with the operation.

When authentication is unsuccessful, the controller 21 does not perform the processing of step S13. Furthermore, the operation request transmitted in step S13 does not need to include authentication information for logging into the second service server 20.

Next, the controller 11 of the first service server 10 receives the operation request through the communication unit 12 (step S14), and determines, based on the access ticket storage unit 133, whether or not the access ticket included in the operation request is valid (step S15).

When it is determined that the access ticket is invalid (step S15; NO), the controller 11 rejects the operation requested by the operation request and does not perform information processing on an object. When it is determined that the access ticket is valid (step S15; YES), the controller 11 proceeds to processing of step S16.

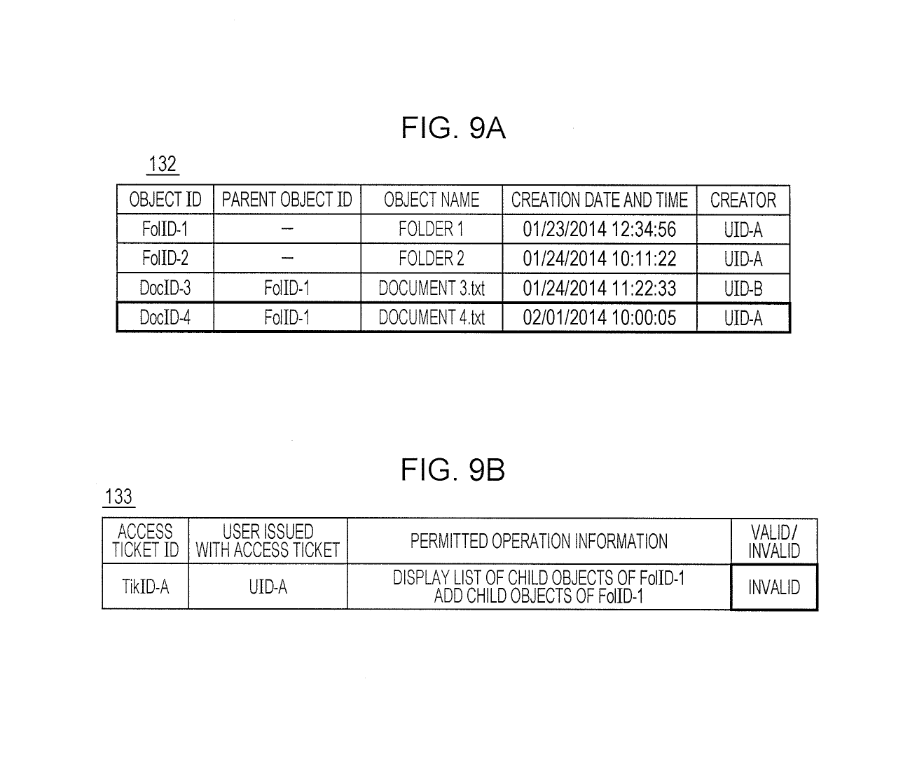

Next, the controller 11 determines whether or not the requested operation matches an operation to be permitted indicated by permitted operation information stored in the access ticket storage unit 133 (step S16). When it is determined that the requested operation matches an operation to be permitted (step S16; YES), the controller 11 permits the operation requested by the operation request and performs information processing on the object in accordance with the permitted operation (step S17). For example, as illustrated in the record in the fourth row of FIG. 9A, the controller 11 causes the object storage unit 132 to store the object of an object ID “DocID-4” as an object whose parent object ID is “FoldID-1”.

When it is determined that the requested operation does not match an operation to be permitted (step S16; NO), the controller 11 rejects the operation requested by the operation request and does not perform information processing on the object (step S18). Furthermore, the controller 11 invalidates the access ticket included in the operation request (step S19). The controller 11 changes, as illustrated in FIG. 9B, for example, the state of the access ticket of the access ticket ID “TikID-A” from “valid” into “invalid” in the access ticket storage unit 133. The processing for invalidating the access ticket may be any type of processing as long as the use of the access ticket is disabled. For example, the controller 11 may instruct the second service server 20 through the communication unit 12 to delete the access ticket. When the controller 21 of the second service server 20 receives the instruction for deletion, the controller 21 deletes the access ticket from the storage unit 23.

Then, the controller 11 performs notification processing for notifying the client apparatus 30 of the user to whom the access ticket has been issued, that the access ticket has been invalidated (step S20). The controller 11 identifies, based on the user information storage unit 131, an email address of the client apparatus 30 of the user for which the access ticket has been invalidated, and transmits an email message indicating that the access ticket has been invalidated, by using the identified email address. When the controller 31 of the client apparatus 30 receives the email message, the controller 31 causes the received email message to be displayed using the user interface unit 34, and notifies the user that the access ticket has been invalidated.

According to the access management system 1 of the first exemplary embodiment described above, even if an access ticket is valid, when an operation which is different from an operation to be permitted set at the time of issuing the access ticket is received, the operation is rejected as an unauthorized operation and the access ticket is invalidated. In this case, the access management system 1 regards an operation request made by using the access ticket as not being a request by a duly authorized person. This is because a request for an operation which is different from an operation set by the client apparatus 30 arouses a suspicion of leakage of an access ticket to a third party and execution of an unauthorized operation on an object by the third party. Even if such a leakage has occurred, the access ticket is invalidated by the access management system 1 on the ground that the operation has been rejected. Therefore, repeated permissions of operations improperly using the access ticket are suppressed.

Furthermore, even in the case where user authentication is successful at the first service server 10 and the second service server 20, since the access ticket is invalidated, an operation improperly using the access ticket is rejected when the client apparatus 30 is used by a third party without authorization.

Furthermore, an operation to be permitted is set by the access management system 1 at the time of issuing an access ticket. Accordingly, the operation to be permitted may be considered as being set by an authorized user.

### Second Exemplary Embodiment

Next, a second exemplary embodiment of the present invention will be described.

In the access management system 1 according to the first exemplary embodiment described above, an operation to be permitted is set by the client apparatus 30. However, in the second exemplary embodiment, setting of an operation to be permitted is not performed in advance. In the description provided below, the same elements as those in the first exemplary embodiment will be represented by the same signs, and explanation for those same elements will be omitted or simplified.

The hardware configuration of the first service server 10 according to the second exemplary embodiment is roughly the same as that of the first exemplary embodiment described above. However, the hardware configuration of the first service server 10 according to the second exemplary embodiment is different from that of the first exemplary embodiment described above in including an access ticket storage unit 133a, in place of the access ticket storage unit 133, and including the operation history storage unit 134.

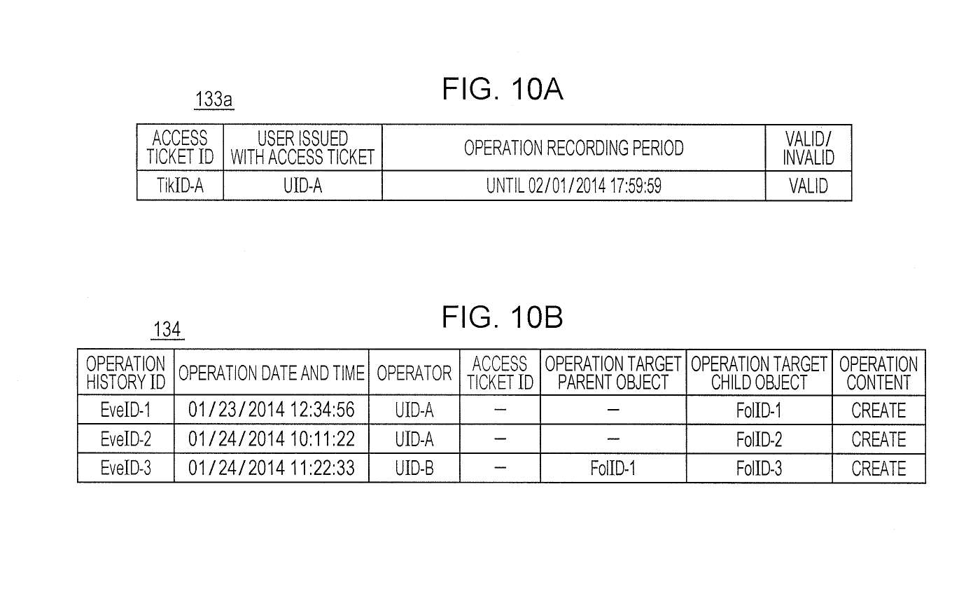

FIGS. 10A and 10B are diagrams for explaining data stored in the first service server 10. FIG. 10A illustrates data stored in the access ticket storage unit 133a, and FIG. 10B illustrates data stored in the operation history storage unit 134.

As illustrated in FIG. 10A, the access ticket storage unit 133a stores information of an access ticket ID, a user issued with access ticket, an operation recording period, and valid/invalid in association with each other for each issued access ticket. The details of the information of the access ticket ID, the user issued with access ticket, and valid/invalid are the same as those in the first exemplary embodiment described above. The operation recording period is a period during which a history of an operation received by the first service server 10 is recorded. The operation recording period is identified by information indicating the ending point of the operation recording period with the time of issuing an access ticket as a starting point.

As illustrated in FIG. 10B, the operation history storage unit 134 stores information of an operation history ID, an operation date and time, an operator, an access ticket ID, an operation target parent object, an operation target child object, and operation content in association with each other for each received operation. The operation history ID is an identifier for uniquely identifying a history of a received operation. The operation date and time represents the date and time when an operation is received. The access ticket ID is an access ticket ID of an access ticket used for an operation. The operation target parent object represents an object ID of a parent object which serves as a target for an operation. The operation target child object represents an object ID of a child object which serves as a target for an operation. The operation content represents the content of a received operation.

The hardware configuration of and data stored in the second service server 20 and the client apparatuses 30 may be the same as those in the first exemplary embodiment described above.

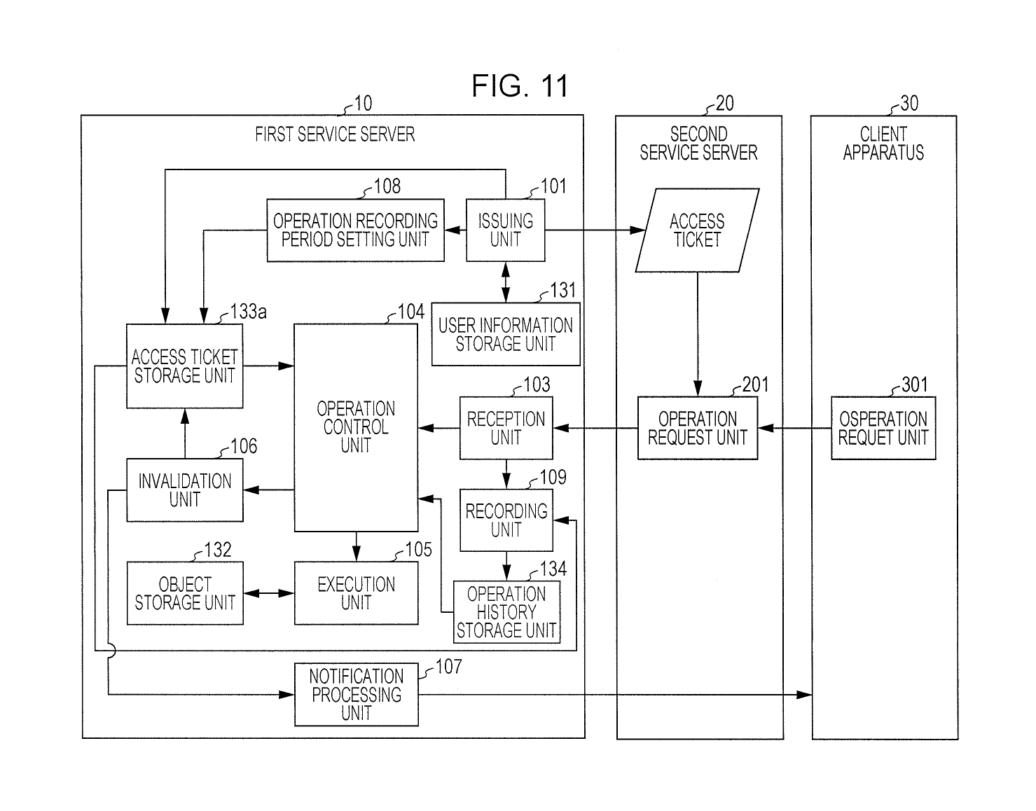

FIG. 11 is a block diagram illustrating a functional configuration of the access management system 1. FIG. 11 illustrates function blocks for implementing functions concerning an access ticket. As illustrates in FIG. 11, the controller 11 of the first service server 10 executes a program and thereby implements functions corresponding to the issuing unit 101, an operation recording period setting unit 108, the reception unit 103, a recording unit 109, an operation control unit 104a, the execution unit 105, the invalidation unit 106, and the notification processing unit 107. The individual function blocks of the issuing unit 101, the reception unit 103, the execution unit 105, the invalidation unit 106, and the notification processing unit 107 implement the same functions as those in the first exemplary embodiment described above.

The operation recording period setting unit 108 is an example of a setting unit according to an aspect of the present invention, and sets an operation recording period (an example of a recording period according to an aspect of the present invention) in accordance with an access ticket when the access ticket is issued. The operation recording period setting unit 108 causes the access ticket storage unit 133a to store information of the set operation recording period.

The recording unit 109 is an example of a recording unit according to an aspect of the present invention, and records a history of an operation received within the operation recording period in the operation history storage unit 134.

The operation control unit 104a is an example of an operation control unit according to an aspect of the present invention, and permits, from among the operations received within the operation recording period, an operation for the case where an access ticket is valid, and rejects an operation for the case where an access ticket is invalid. Furthermore, the operation control unit 104a permits, from among the operations received outside the operation recording period, an operation for the case where an access ticket is valid and which matches an operation identified by an operation history recorded in the operation history storage unit 134 (an example of a second operation according to an aspect of the present invention). The operation control unit 104a rejects an operation which does not match an operation identified by an operation history and an operation for the case where an access ticket is invalid. Here, the operation control unit 104a identifies, based on an operation history, an operation pattern representing regularly performed operations, and rejects an operation which does not match the identified operation pattern. The operation pattern is identified, for example, by the content of a received operation (for example, the order of multiple operations and the interval between operations), and the operation date and time.

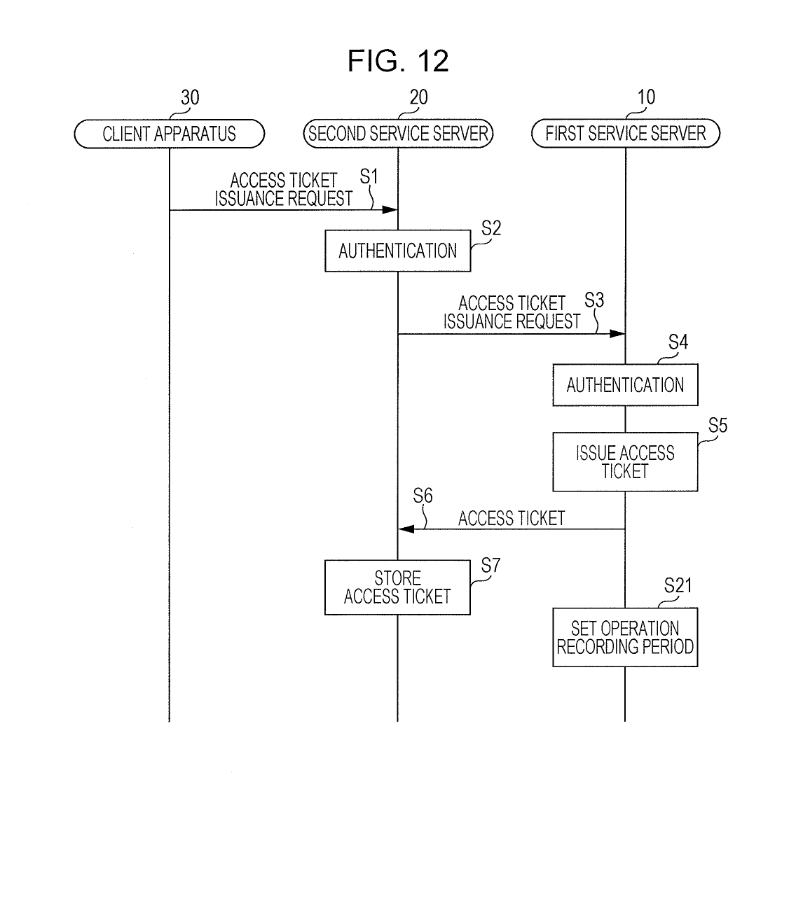

FIG. 12 is a sequence diagram illustrating operation of the access management system 1 at the time of issuing an access ticket. As illustrated in FIG. 12, the operation at the time of issuing an access ticket is roughly the same as that of the first exemplary embodiment described above with the exception that processing corresponding to steps S8 to S10 is not preformed. Instead of that, when the controller 11 of the first service server 10 issues an access ticket in step S5, the controller 11 sets an operation recording period (step S21). The operation recording period may be set with a default duration or by the client apparatus 30.

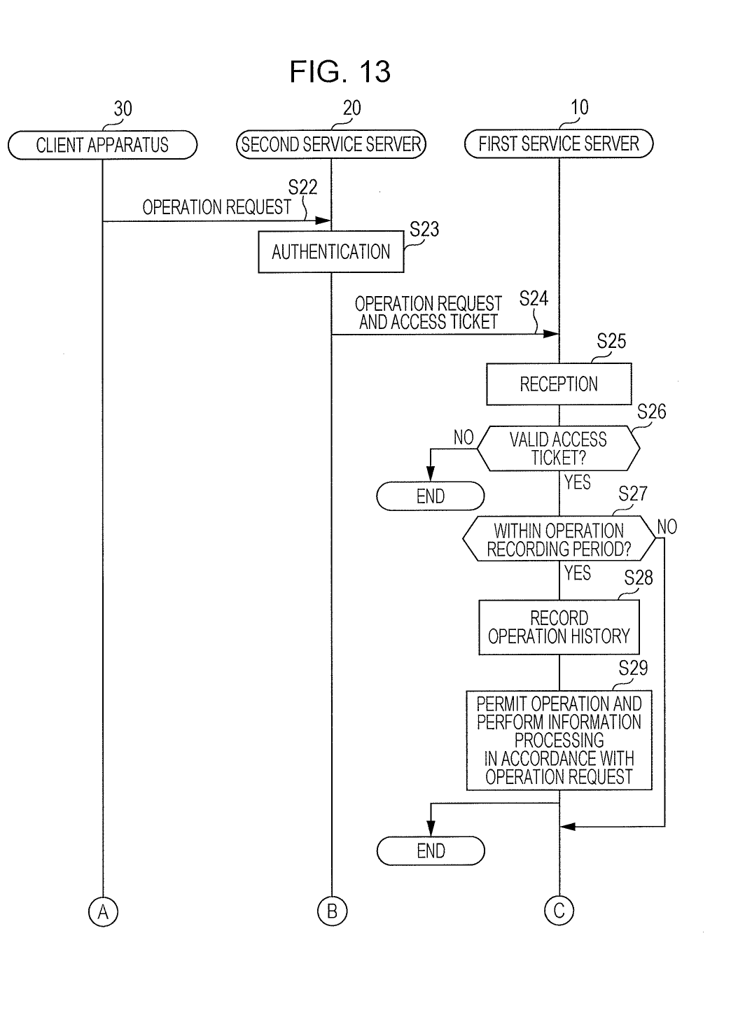

FIG. 13 is a sequence diagram illustrating operation of the access management system 1 at the time of an operation on an object.

First, the controller 31 of the client apparatus 30 transmits an operation request to the second service server 20 through the communication unit 32 (step S22). The operation request includes a user ID, authentication information for logging into the first service server 10, and operation information indicating the operation to request. Next, the controller 21 of the second service server 20 receives the operation request through the communication unit 22, and performs processing for authenticating the user of the client apparatus 30 (step S23). The controller 21 collates authentication information for the second service server 20 included in the operation request with authentication information stored in the storage unit 23. When authentication is successful, the controller 21 transmits the operation request received from the client apparatus 30 and an access ticket issued for the user of the user ID included in the operation request in association with each other to the first service server 10 through the communication unit 22 (step S24). Although not illustrated in FIG. 13, when an operation for object synchronization is requested, the controller 21 performs information processing on the object in accordance with the operation.

When authentication is unsuccessful, the controller 21 does not perform the processing of step S24. Furthermore, the operation request transmitted in step S24 does not need to include authentication information for logging into the second service server 20.

Next, the controller 11 of the first service server 10 receives the operation request through the communication unit 12 (step S25), and determines, based on the access ticket storage unit 133a, whether or not the access ticket included in the operation request is valid (step S26). When it is determined that the access ticket is invalid (step S26; NO), the controller 11 rejects the operation requested by the operation request, and does not perform information processing on an object. When it is determined that the access ticket is valid (step S26; YES), the controller 11 proceeds to processing of step S27.

Next, the controller 11 determines whether or not it is within the operation recording period (step S27). When the controller 11 determines, based on the access ticket storage unit 133a, that it is within the operation recording period (step S27; YES), the controller 11 records the history of the received operation in the operation history storage unit 134 (step S28). Then, the controller 11 permits the operation requested by the operation request, and performs information processing on the object in accordance with the operation (step S29).

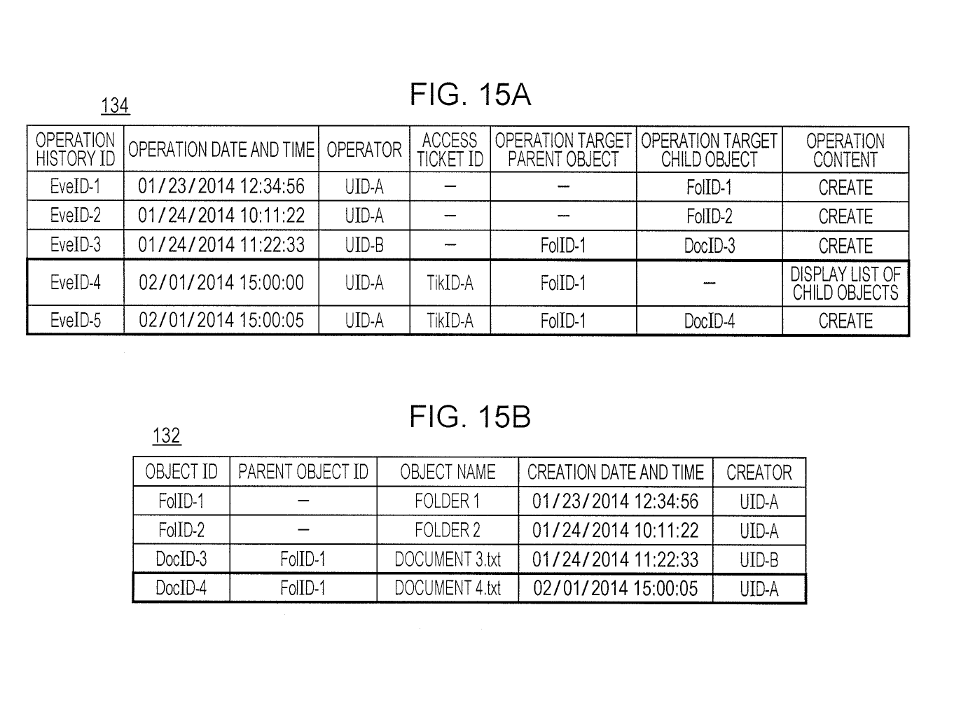

A case where the first service server 10 receives an operation request of operation information “display a list of child objects of FolID-1” at operation date and time “02/01/2014 15:00:00” and then receives an operation request of operation information “add child objects of FolID-1” at operation date and time “02/01/2014 15:00:05”, will be discussed. When receiving the above operation requests, the controller 11 permits the requested operations because the operation dates and times are within an operation recording period. Then, as illustrated in FIG. 15A, the controller 11 causes the operation history storage unit 134 to store the history of the former operation as an operation history ID “EveID-4” and the history of the latter operation as an operation history ID “EveID-5”. As illustrated in the record in the fourth row of FIG. 15B, the controller 11 causes, in accordance with the requested operations, the object storage unit 132 to store the object of the object ID “DocID-4” as an object whose parent object ID is “FoldID-1”.

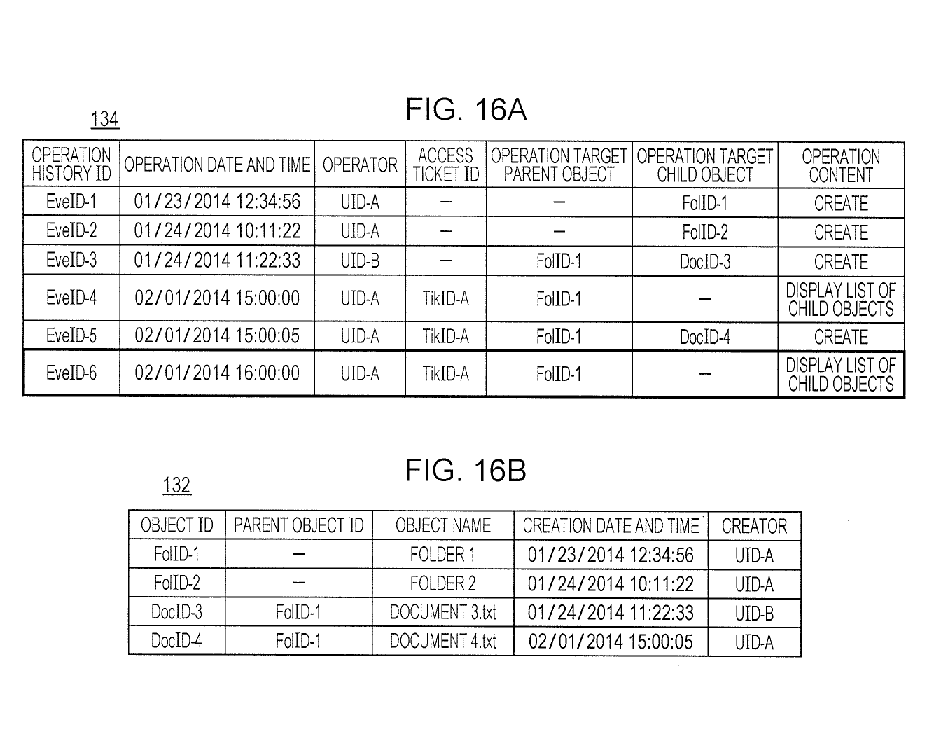

Next, a case where the first service server 10 receives an operation request of operation information “display a list of child objects of FolID-1” at operation date and time “02/01/2014 16:00:00, will be discussed. When receiving the operation request, the controller 11 permits the requested operation because the operation date and time is within the operation recording period. In this case, as illustrated in FIG. 16A, the controller 11 causes the operation history storage unit 134 to store the history of the operation as an operation history ID “EveID-6”. Then, the controller 11 performs, in accordance with the operation requested by the operation request, displaying of a list of child objects whose parent object is represented by the object ID “FoldID-1”. As illustrated in FIG. 16B, there is no change in the object storage unit 132.

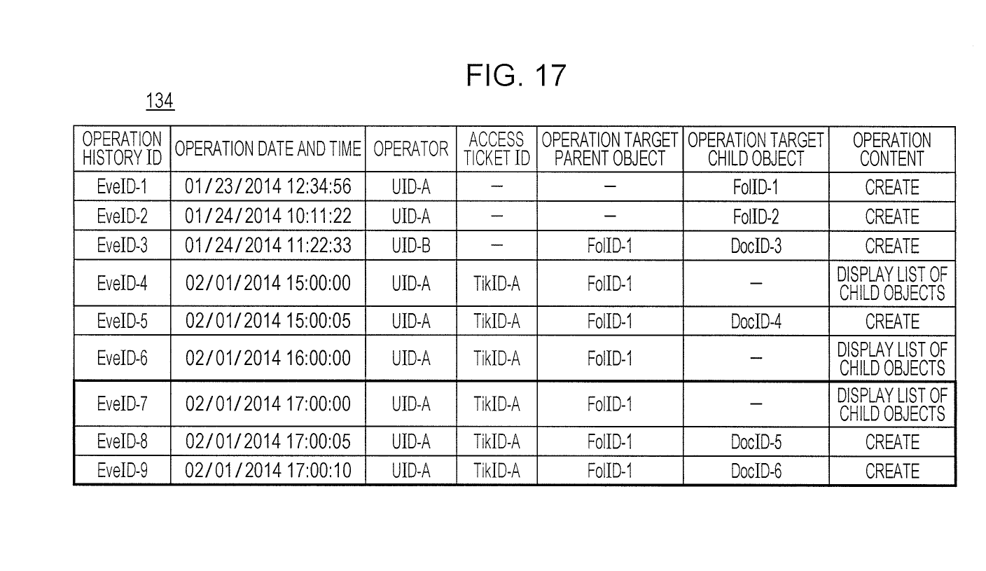

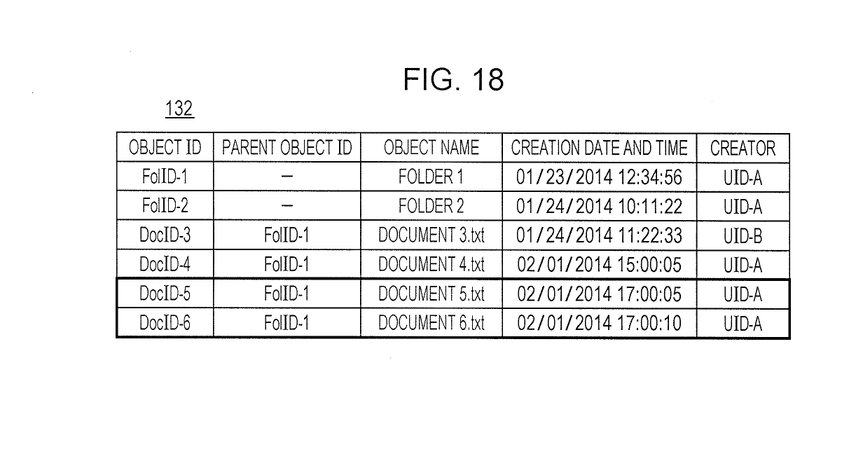

Next, a case where the first service server 10 receives an operation request of operation information “display a list of child objects of FolID-1” at operation date and time “02/01/2014 17:00:00”, an operation request of operation information “add child objects of FolID-1” at operation date and time “02/01/2014 17:00:05”, and an operation request of operation information “add child objects of FolID-1” at operation date and time “02/01/2014 17:00:10”, will be discussed. When receiving the above operation requests, the controller 11 permits the requested operations because the operation dates and times are within the operation recording period. As illustrated in FIG. 17, the controller 11 causes the operation history storage unit 134 to store the history of the first operation as an operation history ID “EveID-7”, the history of the second operation as an operation history ID “EveID-8”, and the history of the third operation as an operation history ID “EveID-9”. As illustrated in the record in the fifth row of FIG. 18, the controller 11 preforms, in accordance with the operations requested by the operation requests, processing for causing the object storage unit 132 to store the object of an object ID “DocID-5” as an object whose parent object ID is “FoldID-1” and to store the object of an object ID “DocID-6” as an object whose parent object ID is “FoldID-1”.

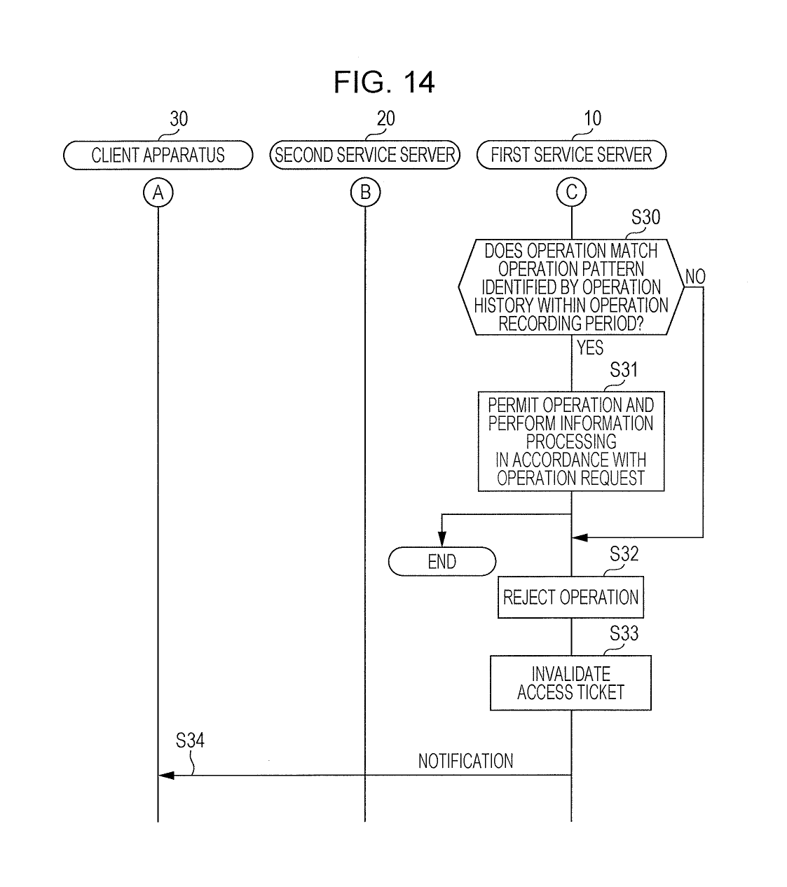

Then, a case where the first service server 10 receives an operation request of operation information “display a list of child objects of FolID-1” at operation date and time “02/01/2014 18:00:00”, will be discussed. When receiving the operation request, the controller 11 determines “NO” in step S27 (see FIG. 13) because the operation date and time is outside the operation recording period. When it is determined that the operation request is outside the operation recording period, the controller 11 determines whether or not the requested operation matches an operation pattern identified by an operation history stored in the operation history storage unit 134 (step S30 in FIG. 14). As illustrated in FIG. 17, an operation pattern that “the operation “display a list of child objects of FolID-1” is requested at an interval of about one hour” and an operation pattern that “the operation “add child objects of FolID-1” is requested several seconds after the operation “display a list of child objects of FolID-1” is requested” are identified, as operation patterns within the operation recording period, based on operation histories stored in the operation history storage unit 134. The controller 11 determines whether the requested operation matches the above identified operation patterns.

With regard to a time interval between specific operations performed and a time between an operation and the subsequent operation in an operation pattern, it is desirable to provide a fixed error range to allow for a certain degree of tolerance.

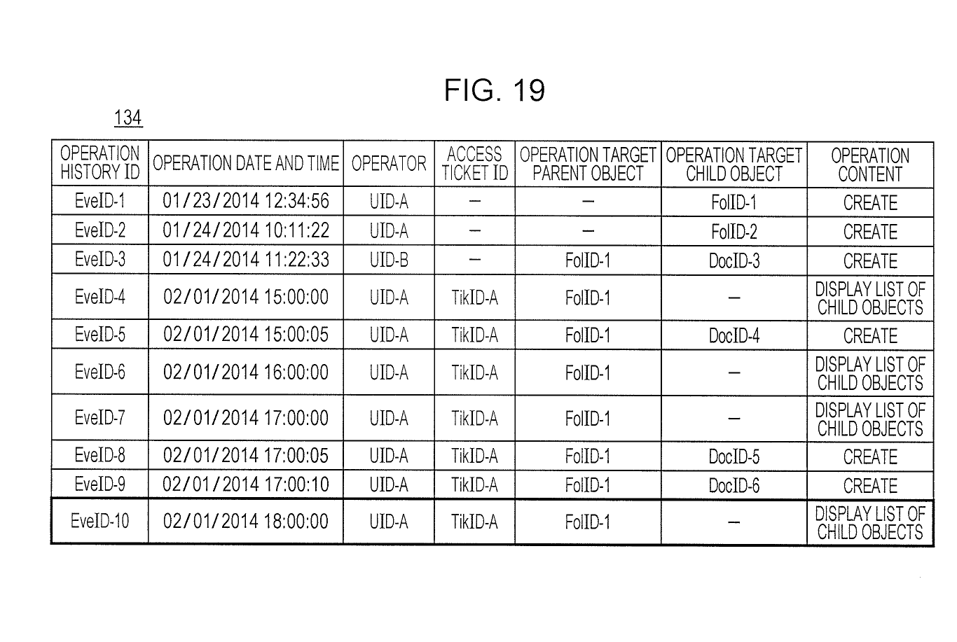

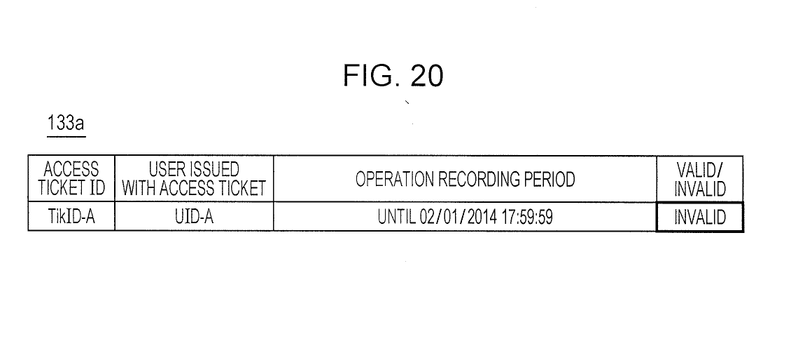

Now, a case where the first service server 10 receives an operation request of operation information “display a list of child objects of FolID-1” at operation date and time “02/01/2014 18:00:00”, will be discussed. In this case, the controller 11 determines that the operation request matches the operation pattern that “the operation “display a list of child objects of FolID-1” is requested at an interval of about one hour”. In this case, the controller 11 determines “YES” in step S30, permits the operation requested by the operation request, and performs information processing on an object in accordance with the operation request (step S31). Here, as illustrated in FIG. 19, the controller 11 causes the operation history storage unit 134 to store the operation history as an operation history ID “EveID-10”. Then, the controller 11 permits the operation requested by the operation request and displays a list of child objects whose parent object is represented by the object ID “FoldID-1”. As illustrated in FIG. 16B, there is no change in the object storage unit 132.

Next, a case where the first service server 10 receives an operation request of operation information “display a list of child objects of FolID-1” at operation date and time “02/01/2014 18:38:34”, will be discussed. In this case, the controller 11 determines that the operation which matches neither the operation pattern that “the operation “display a list of child objects of FolID-1” is requested at an interval of about one hour” nor the operation pattern that “the operation “add child objects of FolID-1” is requested several seconds after the operation “display a list of child objects of FolID-1” is requested” is received. In this case, the controller 11 determines “NO” in step S30, rejects the operation requested by the operation request, and does not perform information processing on an object (step S32). Furthermore, the controller 11 invalidates the access ticket included in the operation request (step S33). The controller 11 changes, based on the access ticket storage unit 133a, the state of the access ticket corresponding to the access ticket ID “TikID-A” from “valid” into “invalid”. The processing for invalidating the access ticket may be any type of processing, as in the first exemplary embodiment described above, as long as the use of the access ticket is disabled.

Then, the controller 11 performs notification processing for notifying the client apparatus 30 of the user to whom the access ticket has been issued, that the access ticket has been invalidated (step S34).

According to the access management system 1 of the second exemplary embodiment described above, even if an access ticket is valid, when an operation request received outside an operation recording period does not match an operation pattern within the operation recording period, the operation is rejected as an unauthorized operation and the access ticket is invalidated. In this case, the access management system 1 regards the operation request made by using the access ticket as not being a request by a duly authorized person. This is because an operation which does not match a regular operation, which is normally performed on a regular basis, arouses a suspicion of leakage of an access ticket to a third party and execution of an unauthorized operation on an object by improper use of the access ticket by the third party. Even if such a leakage has occurred, the access ticket is invalidated by the access management system 1 on the ground that the operation has been rejected. Therefore, repeated permissions of operations improperly using the access ticket are suppressed.

Furthermore, as in the first exemplary embodiment described above, even in the case where user authentication is successful at the first service server 10 and the second service server 20, since the access ticket is invalidated, an operation improperly using the access ticket is rejected when the client apparatus 30 is used by a third party without authorization.

Furthermore, an operation recording period is set by the access management system 1 according to the second exemplary embodiment at the time of issuing an access ticket. Accordingly, an operation received within the operation recording period may be considered as being performed by an authorized user.

### [Variations]

The present invention may be implemented in forms different from the exemplary embodiments described above. Furthermore, variations described below may be combined together.

### (First Variation)

In each of the exemplary embodiments described above, the first service server 10 performs control of the propriety of an operation associated with an access ticket and invalidation of an access ticket for each user. However, there may be a possibility that an access ticket is leaked from a communication path between the first service server 10 and the second service server 20, or the like. To reduce damage caused by such a leakage of an access ticket, the control described below may be performed. In a first variation, the first service server 10 causes, for example, the access ticket storage unit 133 or 133a to store information of an apparatus to which an issued access ticket is to be transmitted (in this case, the second service server 20).

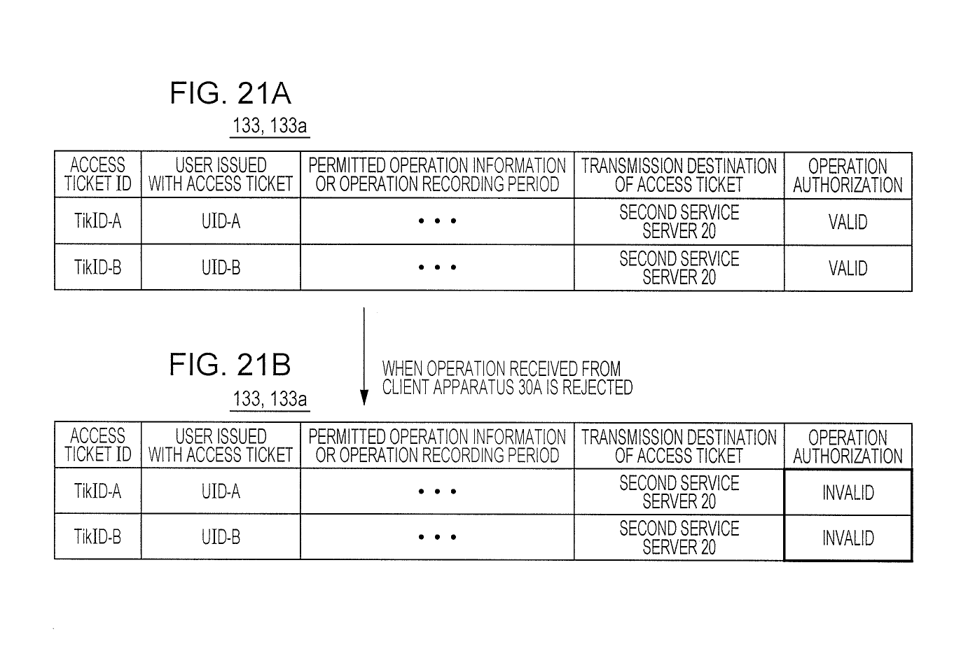

As illustrated in FIG. 21A, a case where an operation received from the client apparatus 30 of a user of a user ID “UID-A” is rejected when access tickets for users of the user ID “UID-A” and the user ID “UID-B” are both valid, will be discussed. In this case, the controller 11 invalidates not only the access ticket for the client apparatus 30A which uses the user ID “UID-A” but also all the other access tickets stored in the second service server 20. That is, the controller 11 invalidates the access ticket issued to the user of the user ID “UID-B” as well as the access ticket issued to the user of the user ID “UID-A”. Thus, even if leakage of an access ticket concerning the second service server 20 occurs, the possibility of unauthorized use of access tickets for multiple users is reduced.

In the first variation, the first service server 10 may invalidate, on the ground that the access ticket for a user has been invalidated, all the other access tickets managed by the second service server 20. Alternatively, the first service server 10 may invalidate, on the ground that the access tickets for predetermined two or more users have been invalidated, all the other access tickets managed by the second service server 20. Thus, when it is considered highly likely that leakage of an access ticket from the second service server 20 has occurred, all the access tickets stored in the second service server 20 are invalidated.

### (Second Variation)

In the first exemplary embodiment described above, the first service server 10 sets an operation to be permitted (an example of a first operation according to an aspect of the present invention). However, the first service server 10 may set an operation to be rejected (an example of a second operation according to an aspect of the present invention). In this case, when an access ticket is valid, the first service server 10 rejects an operation which matches a set operation to be rejected, and permits the other operations.

### (Third Variation)

Part of the configuration or operation described in the foregoing exemplary embodiments may be omitted.

The first service server 10 rejects an unauthorized operation, even without a configuration for invalidating an access ticket, by performing control of permitting, from among operations received from the client apparatus 30, a first operation for the case where an access ticket is valid and by rejecting the first operation for the case where the access ticket is invalid and a second operation which is different from the first operation.

Furthermore, the first service server 10 may be configured not to perform notification processing when an access ticket is invalidated. Furthermore, part of processing for authenticating a user may be omitted. An apparatus that issues an access ticket may be different from the first service server 10, for example, a server apparatus which is dedicated to issuance of an access ticket.

The order of processing performed by the access management system 1 described with reference to the sequence diagrams may be changed. The first service server 10 may set, for example, an operation to be permitted and an operation recording period at a timing different from the time of issuing an access ticket.

Furthermore, a function corresponding to the execution unit 105 according to the foregoing exemplary embodiments may be implemented by an apparatus different from the first service server 10. That is, an information processing apparatus according to an exemplary embodiment may be implemented by an apparatus different from an apparatus which performs information processing in accordance with an operation request.

### (Fourth Variation)

In the exemplary embodiments described above, regular execution of operations is assumed. However, the present invention is not limited to this. For example, in the access management system 1 according to the first exemplary embodiment described above, an operation to be permitted may be set in advance to determine whether or not an irregular operation is an unauthorized operation.

Furthermore, an operation identified by an operation history according to the second exemplary embodiment described above is not limited to an operation pattern identified by multiple operations. For example, an operation identified by an operation history may be identified by a communication address (for example, an IP address) assigned to the client apparatus 30 that performs the operation.

### (Fifth Variation)

Furthermore, information processing performed by the first service server 10 may not be related to a service of uploading data of the client apparatus 30. The information processing performed by the first service server 10 may be related to, for example, a service of downloading data from a server apparatus or a service of causing a server apparatus to execute a predetermined program and causing a client apparatus to acquire the processing result.

### (Sixth Variation)

The functions implemented by the controller 11 of the first service server 10, the controller 21 of the second service server 20, and the controller 31 of the client apparatuses 30 according to the exemplary embodiments described above may be implemented by one or multiple hardware circuits, by executing one or multiple programs, or by a combination thereof. When the functions of the controllers 11, 21, and 31 are implemented by using a program, the program may be provided in a form stored in a computer readable recording medium, such as a magnetic recording medium (a magnetic tape, a magnetic disk (a hard disk drive (HDD), a flexible disk (FD)), etc.), an optical recording medium (an optical disk etc.), a magneto-optical recording medium, a semiconductor memory, or the like. The program may also be distributed via a network.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a reception unit that receives an operation on data;
an operation control unit that performs control of permitting, from among received operations, a first operation which is associated with authorization information for a case where authorization information indicating authorization for an operation is valid, and rejecting the first operation for a case where the authorization information is invalid and a second operation which is different from the first operation; and
an invalidation unit that invalidates the authorization information when the second operation is rejected.

2. The information processing apparatus according to claim 1, further comprising:
an issuing unit that issues the authorization information; and
a setting unit that sets, when the authorization information is issued, the first operation or the second operation in accordance with the authorization information.

3. The information processing apparatus according to claim 1, further comprising:
a recording unit that records a history within a recording period during which histories of the received operations are recorded,
wherein the operation control unit rejects, from among operations received outside the recording period, an operation that does not match an operation identified by the recorded history as the second operation.

4. The information processing apparatus according to claim 3, further comprising:
an issuing unit that issues the authorization information; and
a setting unit that sets, when the authorization information is issued, the recording period in accordance with the authorization information.

5. The information processing apparatus according to claim 1, wherein
the operation control unit rejects the second operation even when authentication of a user who performs the received operation is successful.

6. The information processing apparatus according to claim 1,
wherein the reception unit receives the operation performed by a plurality of users through an external apparatus, and
wherein the invalidation unit invalidates the authorization information used by the plurality of users when the second operation received through the external apparatus is invalidated.

7. The information processing apparatus according to claim 1, further comprising:
a notification processing unit that performs, when the authorization information is invalidated, notification processing to a user who uses the authorization information.

8. An information processing method comprising:
receiving an operation on data;
performing control of permitting, from among received operations, a first operation which is associated with authorization information for a case where authorization information indicating authorization for an operation is valid, and rejecting the first operation for a case where the authorization information is invalid and a second operation which is different from the first operation; and
invalidating the authorization information when the second operation is rejected.

9. A non-transitory computer readable medium storing a program causing a computer to execute a process for information processing, the process comprising:
receiving an operation on data;
performing control of permitting, from among received operations, a first operation which is associated with authorization information for a case where authorization information indicating authorization for an operation is valid, and rejecting the first operation for a case where the authorization information is invalid and a second operation which is different from the first operation; and
invalidating the authorization information when the second operation is rejected.
